(19) United States
(12) Patent Application Publication
(10) Pub. No.: US 2005/0242168 A1
(43) Pub. Date: Nov. 3, 2005

(54) Network scanner interface

(75) Inventors: Carl J. Tesavis, Spencerport, NY (US); Lawrence J. Bernstein, Honeoye Falls, NY (US); James A. Oliver, Webster, NY (US)

Correspondence Address: Mark G. Bocchetti;Eastman Kodak Company, Patent Legal Staff, 343 State Street, Rochester, NY, 14650-2201, US

(73) Assignee: Eastman Kodak Company

(21) Appl. No.: 10/834,452

(22) Filed: Apr. 29, 2004

(51) Int. Cl. G06F 17/00; G06K 5/00

(52) U.S. Cl. 235/375; 235/382

(57) ABSTRACT

A network interface (20) comprises a microprocessor having an access port (50). A portable memory device (60) is capable of being inserted into the access port (50). A software datafile is contained on the portable memory device. Office equipment (10) is connected to the microprocessor. The microprocessor reads the datafile contained on the portable memory device and configures operating characteristics of the office equipment.

### CROSS REFERENCE TO RELATED APPLICATIONS

Reference is made to commonly-assigned copending U.S. patent application Ser. No. 10/696,264, filed Oct. 29, 2003, entitled EASY SCAN KIOSK FOR LOW VOLUME DOCUMENT SCANNER, by Tesavis et al., the disclosure of which is incorporated herein.

### FIELD OF THE INVENTION

The invention relates in general to network devices and in particular, to an interface for configuring equipment connected to the network.

### BACKGROUND OF THE INVENTION

Many document scanners can be interfaced directly to a customers Ethernet based network. These scanners have a common problem in that they require the user to employ a small, difficult to use keypad and display to enter their user ID and scanner setup information for each batch. Some machines have programmable function keys so that users can select from a limited number of configuration options. This typically can only be done once the user enters their user ID and possibly a password via the cumbersome keypad interface. This is still a less than optimal solution. Often this information is repetitive with an individual being required to provide his or her ID and scanner setup several times a day.

U.S. Pat. No. 6,464,140 solves a similar problem for network scanners. Profiles are created representing different preferences for document processing and associated with different identification codes (ID). The identification codes are read, the ID is mapped to a data file, the data is received by an input device, and the data is processed according to the preference in the profile. Using this system, however, the identification code and other similar information still has to be input, usually by a small keypad as discussed above. Thus, it is seen that there is a need to provide an easy to use interface to a network connected document scanner.

### SUMMARY OF THE INVENTION

Briefly, according to one aspect of the present invention a network interface comprises a microprocessor having an access port. A portable memory device containing a software datafile is inserted into the access port. The microprocessor reads the datafile contained on the portable memory device and configures operating characteristics of the office equipment.

Networked scanning requires that the scanners interface allow the document scanner to be placed directly on a customers Ethernet based network running TCP/IP. For a given batch or session a specific user must be associated with the scanner. According to this invention this process will be made easy for the user by providing an easy-share scanner interface. This interface employs a portable storage device similar to the commonly available FLASH key pen portable storage device or equivalent, hereafter referred to as an easy-share access device, in association with a software application to create scanning profiles.

The invention and its objects and advantages will become more apparent in the detailed description of the preferred embodiment presented below.

### BRIEF DESCRIPTION OF THE DRAWINGS

FIG. 1 is a schematic perspective view of equipment associated with the present invention.

FIG. 2 shows an easy-share FLASH key pen.

FIG. 3 shows a scanner mounted on the easy-share base and a FLASH key pen device.

FIG. 4 shows a screenshot of a user interface according to the present invention.

FIG. 5 shows an example of the present invention using a barcode.

FIG. 6 is a flow chart according to the present invention.

### DETAILED DESCRIPTION OF THE INVENTION

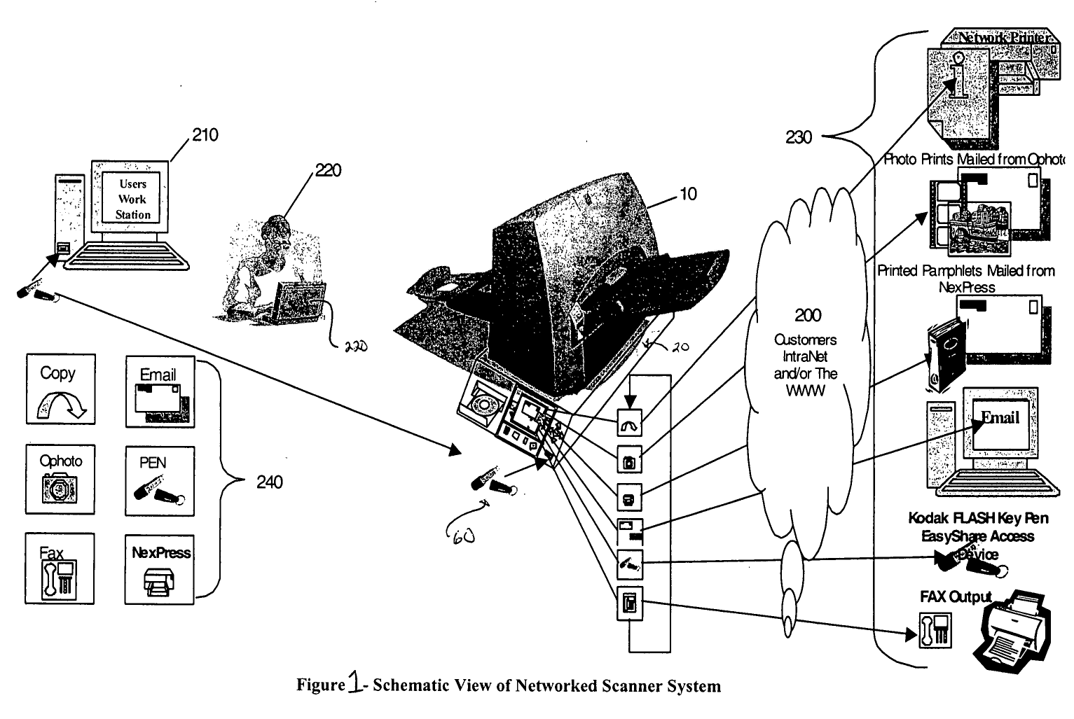

FIG. 1 is a schematic perspective showing a networked scanner 10 with the easy-share interface would or scanner dock 20. A user 220 configures his scanning profiles 300, shown in FIG. 6 and discussed in more detail below, at a remote personal computer or workstation 210 using an easy-share profile configuration software application in a configuration session.

A scanning profile 300 would include such things as destination of scanned images (i.e., network drive, local storage device, i.e., on the scanner itself, directory path or e-mail account, session timeout value, scanning resolution, color bitonal or grayscale output, compression, cropping, deskew, etc. For scan to print or multi-function peripheral (MFP) the scanning profile 300 would be configured to indicate the network printer to which to direct the output 230, shown in FIG. 1, how many copies to print, snail mail address or mail stop to ship the prints to, along with any other output related parameters. In the scan to print case, the user could then pickup the hard copies of their scanned documents at the printer or they would be delivered via interdepartmental or regular mail per the users scanning profile.

The scanning profile is associated with a user control icon 240. The user control icons 240 and their mapping to scanning profiles will be stored directly on the easy-share access portable memory device 60 as records of a configuration file. When a user wants to scan a batch of documents they assume either one of their previous scanning profiles 300 is okay (the prevalent case) or they modify or create a new profile at their workstation 210 using the previously specified software application in a configuration session. Once this is complete, the user updates the configuration file on the easy-share portable memory device. In the preferred embodiment device 60 is a FLASH key pen. The user removes the FLASH key pen 60 from the workstation access port and ends the configuration session.

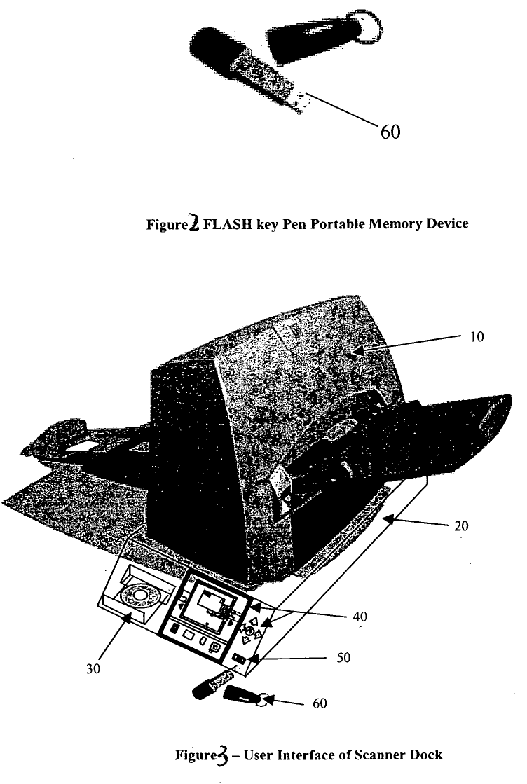

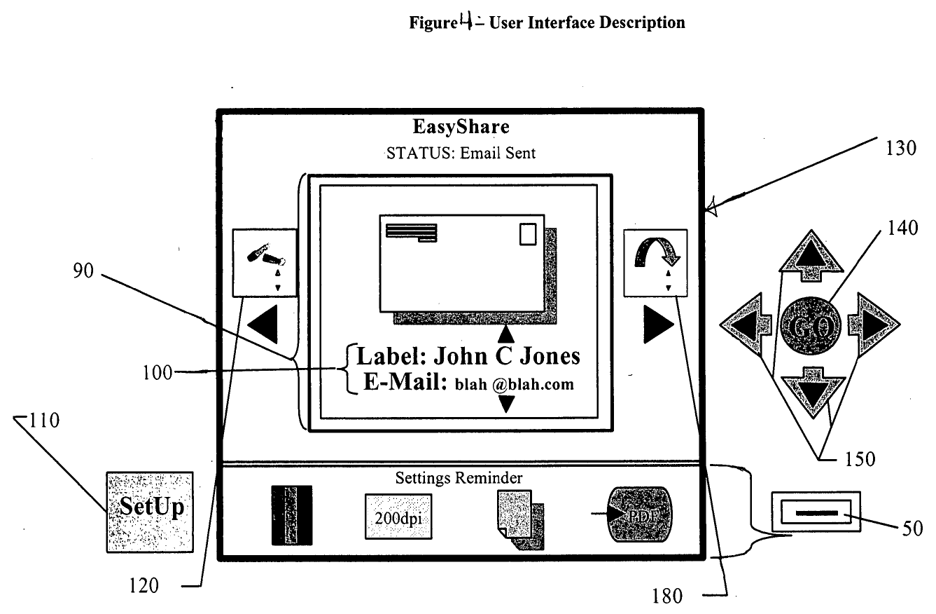

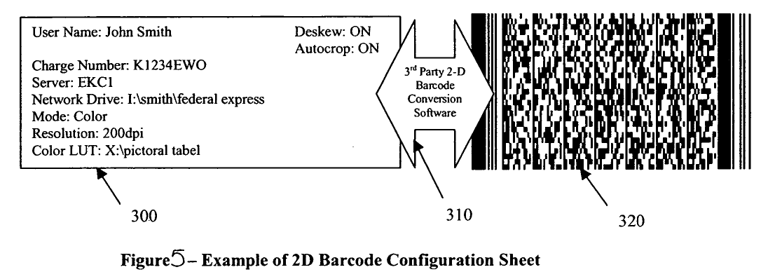

The user 220 then starts a scanning session, shown in FIG. 2, by walking up to the most convenient networked document scanner 10 and plugging the easy-Share FLASH key pen 60 onto the access port 50 of the scanner dock 20. The embedded microprocessor, not shown, reads the configuration file and displays the custom user control icons 240. The document scanner 10 is logged on the network 200, shown in FIG. 1, as the user 220. The user selects the desired scanning profile, shown in FIG. 4, by navigating through the user control icons 240, shown in graphical display 130. In the example shown the current active function 90 is “scan to e-mail.” The next function left 120, as shown in FIG. 4, is “scan to FLASH key pen” and the next function right 180, is shown in the example as “copy.” These functions are selected by using the navigation buttons 150. The user then places the documents to be scanned for this scanning session in the input tray and depresses the “GO” button 140. The scanner is configured per the profile associated with the selected user control icon 240 and the batch of documents is scanned with the resultant images routed per the scanning profile 300 to the indicated destinations 230. Removing the easy-share FLASH key pen 60 from the access port 50 will end the scanning session.

Use of the easy-share networked scanner 10 from the perspective of its user interface 40 is described in more detail below. Graphical display 130 with six associated buttons; four directional arrow keys 150; “GO” button 140; and setup button 110, activate simple switches to generate input signals forming a intuitive control interface. The main focus of this control interface FIG. 4 is simplicity. This is accomplished by having a flat system of control layers or menus. There will be only one layer for normal operation. This rule must be strictly adhered to in order to provide a competitive advantage over current networked scanners and other shared office equipment like multifunction peripherals (MFPs) with which it will compete. Since the FLASH key pen has already set configurations, usually only the GO button 140 will be pressed.

Another key feature, which is important to the easy-share scanner docks 20, is the fact that most if not all equipment configuration will be accomplished on the users workstation 210 and not on the document scanner 10 or scanner dock 20. This will be done by employing an application specifically designed for ease of use, which runs on the users workstation 210, remotely from the scanner. The purpose of this application is to disassociate any unpleasant experience connected with equipment configuration from the use of the easy scan scanner and thus promote a positive opinion of the equipment. The resulting configuration will be communicated to the easy-share scanner dock 20 by means of a portable memory device 60 in the form of a FLASH key pen 60 or equivalent portable memory technology. In addition to being capable of storing the resultant configuration files containing profile records 300 mapped to control icons 240 it will provide the user an additional mechanism for storing and transporting scanned images 230. This will promote demand for the interface by users of shared office equipment and drive sales of document scanners 10.

The present invention differs from competitive equipment in two main areas, perceived ease of use of the device, and ability to control all machine attributes at the machine without a shared networked database application. Prior art networked scanning devices often require alphanumeric keypads to input complex information such as IP addresses, e-mail addresses, machine configuration data and or unique user IDs. Typically with this type of equipment the unique IDs are then associated with configurations stored in complex networked database applications or directly on the machines memory. There are many data points that indicate including complex interfaces of this nature on shared office equipment present a major detractor to the acceptance of the equipment by common non-technical users. Also the requirement for complex networked applications with their associated databases has a high entry cost and require a significant system administration effort. Additionally configuration applications of this nature tend not to be as user friendly or understandable by typical non-technical users. The non-technical user 220 of shared office equipment is the population of users that the easy-share scanner dock 20 is targeted to benefit. The user interface 40 described in this document is part of a system that should address a majority of the current concerns which non-technical users of shared office equipment experience, both perceived and real.

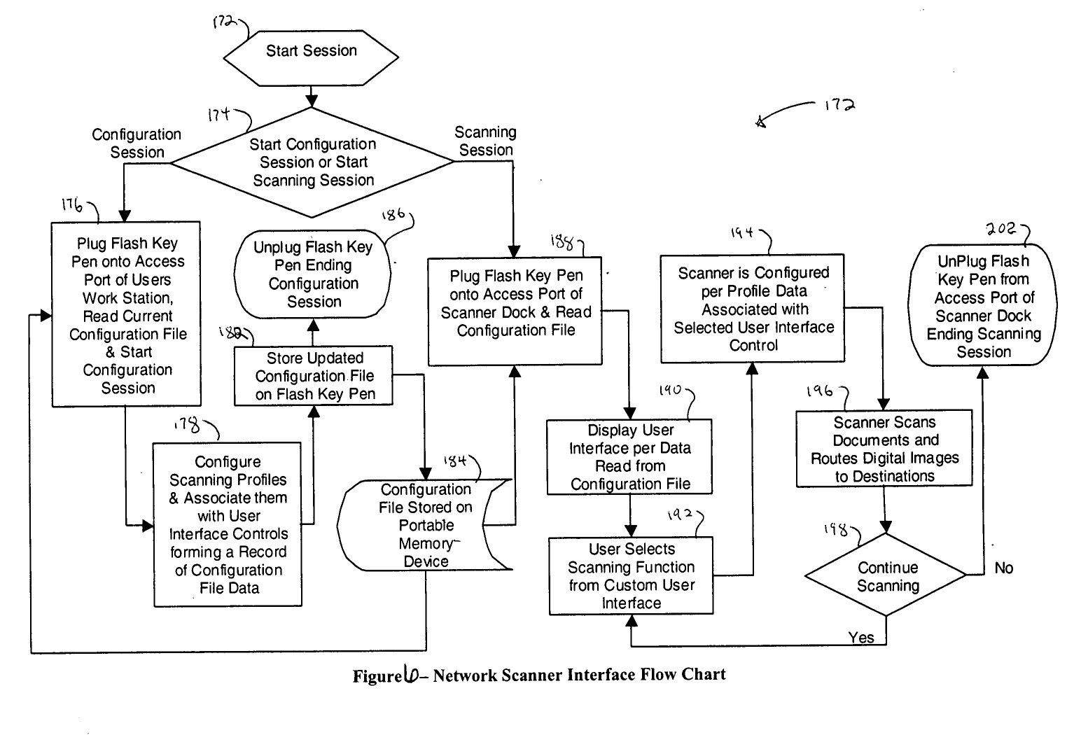

The easy-scan portable memory technology suggested for communicating the user control and scanning profile information has many functional equivalents. These alternate technologies could be substituted for or used in addition to the aforementioned easy-share FLASH key pen. Examples are; scanable two-dimensional (2-D) barcode ID card, shown in FIG. 5, a simple keypad interface, finger print recognition device, and RFID device to name a few. Another embodiment may include a combination of these login technologies.

The 2-D barcode access card method is unique and will be described in additional detail. There is readily available software 310 to create two-dimensional barcodes 320, which contain a significant amount of information on a small piece of paper 320. These access cards could be authored at the users personal computer or workstation in a simple text editor or with a Windows application with pull downs and check boxes in the form of the aforementioned configuration application. The text is then fed into the conversion software creating the image of 2-D barcode 320, as shown in FIG. 5. This image can subsequently be printed on a sheet of paper or cardstock sized such that the user can easily slip them into their shirt pocket or wallet. This access card 320 would be the first sheet in a stack of documents to be scanned on a network scanner. Sheets containing 2-D barcodes could also be included intermingled within the batch to change the configuration or network destination 230, etc. within a batch. The 2-D barcode access card 320 would contain the user ID and the other configuration data 300 previously described as scanning profile information. The result of the image of the access card being correctly decoded 310 would be that the scanner would be logged onto the network 200 as the specified user 220 or some other generic login and the scanner configured per the user scanning profile. This process would be very similar to that previously described in the easy-share FLASH key pen 60 use case above.

In yet another embodiment the user configures his or her scanning profile at a remote personal computer or workstation as previously described, and stores it on a RF capable device. The scanning profile will be stored directly on the RF capable device. When a user wants to scan a set of documents they assume either their previous scanning profile is okay (the prevalent case) or they update their profile for the specific batch to be scanned at their workstation. They then simply walk up to the most convenient networked scanner and bring their easy-share RFID fob into close physical proximity to the scanner. Once the scanner has recognized the user by the RFID device or equivalent technology it logs them onto the network with their ID. Once logged on the scanner is loaded with the users scanning profile from the RFID device and is ready to scan and at this point the scanner responds with a beep. The user then places the documents to be scanned for this session in the input tray and scanning begins. The batch can be ended by means of one final scan of the active users fob, by a timeout resulting from the active user not using the scanner for a set period (walk away), or when a new user wands their fob to begin a new scanning session. When a new and different user begins a session by holding their fob near the scanner, any previous session, which has not yet timed out will be terminated and the new session begun.

With any of these previously described methods, the process to use the networked document scanner will be simple for the user 220, which will promote use of the document scanner for scan to print, OCR, PDF, MFP, or networked archiving and other yet to be determined applications. These types of applications could result in the easy-share networked scanner being prevalent in the workplace and highly desirable for office installations.

A network scanner flowchart in FIG. 6. At the start of the session 172 the user starts the session 174 by choosing either the configuration session or the scanning session. If the configuration session is used, the FLASH key pen is plugged into the users workstation at 176. The current configuration files stored on the FLASH key pen are then read by the workstation. New configurations are then created or current configuration files on the FLASH key pen are edited and updated at 178. The new configuration files are stored on the FLASH key pen at 182. The files are written to the FLASH key pen at 184. The FLASH key pen is unplugged to end the session at 186.

The FLASH key pen is moved to a second device, such as a scanner, and plugged into an access port of the scanner at 188. The user interface data is read from the FLASH key pen at 190 and the user selects scanning information at the customer user interface at 192. The scanner is configured according to the profile data on the selected user interface control at 194. The scanner scans the documents and routes the digital images to the destinations selected at 196. At this point there is an option of continuing scanning or unplugging the FLASH key pen at 198. If additional scanning is selected the user selects scanning functions from the custom user interface at 192. If the user decides to discontinue the session, he or she unplugs the FLASH key pen from the access port of the scanner dock at 202.

The invention has been described in detail with particular reference to certain preferred embodiments thereof, but it will be understood that variations and modifications can be effected within the scope of the invention.

### PARTS LIST

10 document scanner
20 scanner dock
30 CD/RW Drive
40 user interface
50 access port
60 portable memory device (FLASH key pen)
90 current active function
110 setup button
120 next function LEFT
130 graphical display
140 GO button
150 LEFT, RIGHT, UP, DOWN navigation buttons
172 start of session
174 user starts session
176 FLASH key pen plugged into users workstation
178 configurations on FLASH key pen edited and updated
180 next function RIGHT
182 new configurations stored on FLASH key pen
184 files written to FLASH key pen
186 FLASH key pen unplugged
188 FLASH key pen plugged into access port of scanner
190 user interface data read from FLASH key pen
192 user selects scanning information at customer user interface
194 scanner configured
196 destinations selected
198 option of continuing scanning or unplugging FLASH key pen
200 network
202 unplug FLASH key pen from access port of scanner dock
210 user workstation
220 user
230 destination for images
240 control icons
300 scanning profile
310 2-D barcode software
320 image of resultant 2-D barcode

1. A network interface comprising:
a microprocessor having an access port;
a portable memory device which is capable of being inserted into said access port;
a software datafile contained on said portable memory device;
office equipment connected to said microprocessor; and
wherein said microprocessor reads said datafile contained on said portable memory device and configures operating characteristics of said office equipment.

2. A network interface as in claim 1 wherein said portable memory device comprises flash memory.

3. A network interface as in claim 1 wherein said portable memory device comprises a flash key pen.

4. A network interface as in claim 1 wherein said portable memory device comprises a minidisk.

5. A network interface comprising:
a workstation having an access port;
a portable memory device which is capable of being inserted into said access port;
an application program running on said workstation; and
wherein said application program creates a software datafile on said portable memory device.

6. A network interface as in claim 5 wherein said datafile defines operating characteristics of a office equipment

7. A method of configuring office equipment comprising:
inserting a portable memory device into an access port on a workstation;
creating a datafile on said portable memory device;
removing said portable memory device from said access port;
inserting said portable memory device into an access port on a microprocessor;
reading said datafile on said portable memory device; and
configuring office equipment connected to said microprocessor with said datafile.

8. A method as in claim 7 wherein said datafile defines operating characteristics of a office equipment

9. A network interface comprising:
a microprocessor;
a portable memory device which is capable of being accessed by said microprocessor;
a software data file contained on said portable memory device;
office equipment connected to said microprocessor; and
wherein said microprocessor reads data files contained on said portable memory device and configures operating characteristics of said office equipment.

10. A network interface as in claim 9 wherein said portable memory device comprises a radio frequency (RF) device.

11. A network interface as in claim 9 wherein said portable memory device comprises a barcode card.
